(19) United States
(12) Patent Application Publication
(10) Pub. No.: US 2026/0081213 A1
(43) Pub. Date: Mar. 19, 2026

(54) FLUORIDE ION CONDUCTOR AND FLUORIDE ION BATTERY

(71) Applicants: TOYOTA JIDOSHA KABUSHIKI KAISHA, Toyota-shi (JP); INSTITUTE OF SCIENCE TOKYO, Tokyo (JP)

(72) Inventors: Takeshi TOJIGAMORI, Sunto-gun (JP); Naoki Matsui, Tokyo (JP); Ryoji Kanno, Tokyo (JP)

(73) Assignees: TOYOTA JIDOSHA KABUSHIKI KAISHA, Toyota-shi (JP); INSTITUTE OF SCIENCE TOKYO, Tokyo (JP)

(21) Appl. No.: 19/304,958

(22) Filed: Aug. 20, 2025

(30) Foreign Application Priority Data
Sep. 19, 2024 (JP) 2024-162645

(51) Int. Cl. H01M 10/0562

(52) U.S. Cl. CPC H01M 10/0562; H01M 2300/008

(57) ABSTRACT

A fluoride ion conductor is represented by the following composition formula (1): A₁₋ₓAEₓM₂P₇₊ₓ . . . (1) (wherein A=Na, K, Rb, Cs, or a combination thereof; AE=Ca, Sr, Ba, or a combination thereof; M=Sc, Y, Ln, (Ln is a lanthanoid element), Al, Ga, In, or a combination thereof; and 0<x<1). A fluoride ion battery includes the fluoride ion conductor as a solid electrolyte for fluoride ion batteries.

### CROSS-REFERENCE TO RELATED APPLICATION

This application claims priority to Japanese Patent Application No. 2024-162645 filed on Sep. 19, 2024. The disclosure of the above-identified application, including the specification, drawings, and claims, is incorporated by reference herein in its entirety.

### BACKGROUND

### 1. Technical Field

The disclosure relates to a fluoride ion conductor and a fluoride ion battery.

### 2. Description of Related Art

As disclosed in N. I. Sorokin et al., “Anion Transport in BaR₂F₈ Crystals at Elevated Temperatures”, Russian Journal of Electrochemistry, Vol. 38, No. 5, 2002, pp. 522-525, Y. LEFUR et al., Structure cristalline de la phase β-KYb₂F₇, Journal of Solid State Chemistry Vol. 35, 1980, pp. 29-33, K. E. D. Wapenaar et al., Conductivity Enhancement in Ba₁₋ₓLaₓF₂₊ₓ Solid Electrolytes, Solid State Ionics No. 5, 1981, pp. 637-640, and A. Duvel et al., “Mixed Alkaline-Earth Effect in the Metastable Anion Conductor Ba₁₋ₓCaₓF₂ (0≤x≤1): Correlating Long-Range Ion Transport with Local Structures Revealed by Ultrafast ¹⁹F MAS NMR”, The Journal of Physical Chemistry C, 2011, No. 115, pp. 23784-23789, fluorides different in composition are known. They can be used as fluoride ion conductors.

For example, N. I. Sorokin et al., “Anion Transport in BaR₂F₈ Crystals at Elevated Temperatures”, Russian Journal of Electrochemistry, Vol. 38, No. 5, 2002, pp. 522-525 discloses that BaR₂F₈ (R: rare-earth) exhibits ion conductivity on the order of 10⁻³ S·cm⁻¹ at 800° C.

Further, for example, Y. LEFUR et al., Structure cristalline de la phase β-KYb₂F₇, Journal of Solid State Chemistry Vol. 35, 1980, pp. 29-33 discloses KIn₂F₇-type KYb₂F₇ having a structure similar to the structure disclosed in N. I. Sorokin et al., “Anion Transport in BaR₂F₈ Crystals at Elevated Temperatures”, Russian Journal of Electrochemistry, Vol. 38, No. 5, 2002, pp. 522-525. It should be noted that Y. LEFUR et al., Structure cristalline de la phase β-KYb₂F₇, Journal of Solid State Chemistry Vol. 35, 1980, pp. 29-33 does not disclose ion conductivity.

### SUMMARY

Fluoride ion conductors have room for improvement in their ion conductivity.

It is an object of the disclosure to provide a fluoride ion conductor having high ion conductivity and a fluoride ion battery including such a fluoride ion conductor as a solid electrolyte for fluoride ion batteries.

The present inventors have found that the above object can be achieved by the following means.

### First Aspect

A first aspect of the disclosure relates to a fluoride ion conductor represented by the following composition formula (1):

$${A}_{1 - x} {AE}_{x} {M}_{2} {F}_{7 + x} \qquad ( 1 )$$

(wherein
A=Na, K, Rb, Cs, or a combination thereof;
AE=Ca, Sr, Ba, or a combination thereof;
M=Sc, Y, Ln, (Ln is a lanthanoid element), Al, Ga, In, or a combination thereof; and
0<x<1).

### Second Aspect

The fluoride ion conductor according to the first aspect may be represented by the following composition formula (2):

$${A}_{1 - x} {Ba}_{x} {M}_{2} {F}_{7 + x} \qquad ( 2 )$$

(wherein
A=K, Rb, or a combination thereof;
M=Yb, Lu, or a combination thereof; and
0.025≤x≤0.9).

### Third Aspect

The fluoride ion conductor according to the first aspect may be represented by the following composition formula (3):

$${A}_{1 - x} {Ba}_{x} {Er}_{2} {F}_{7 + x} \qquad ( 3 )$$

(wherein
A=K, Rb, or a combination thereof; and
0.2≤x≤0.8).

### Fourth Aspect

The fluoride ion conductor according to the first aspect may be represented by the following composition formula (4):

$${K}_{1 - x} {Ba}_{x} {Lu}_{2} {F}_{7 + x} \qquad ( 4 )$$

(wherein 0.025≤x≤0.5).

### Fifth Aspect

A fifth aspect of the disclosure relates to a fluoride ion battery including the fluoride ion conductor according to any one of the first aspect to the fourth aspect as a solid electrolyte for fluoride ion batteries.

The disclosure makes it possible to provide a fluoride ion conductor having high ion conductivity and a fluoride ion battery including such a fluoride ion conductor as a solid electrolyte for fluoride ion batteries.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view of an example of a fluoride ion battery according to the disclosure;

FIG. 2 is an X-ray diffraction spectrum of K_{0.9}Ba_{0.1}Yb₂F_{7.1};

FIG. 3 is an X-ray diffraction spectrum of K₁₋ₓBaₓYb₂F₇₊ₓ (0≤x≤1);

FIG. 4 is an X-ray diffraction spectrum of K_{0.9}Ba_{0.1}M₂F_{7.1} (M=Sc, Lu, Yb, Tm, and Er);

FIG. 5 is an X-ray diffraction spectrum of Rb_{0.65}Ba_{0.35}M₂F_{7.35} (M=Dy, Y, and Er);

FIG. 6 is an X-ray diffraction spectrum of Rb₁₋ₓBaₓEr₂F₇₊ₓ (0.2≤x≤0.8);

FIG. 7A shows a crystalline structure of K_{0.975}Ba_{0.025}Yb₂F_{7.025};

FIG. 7B shows a crystalline structure of K_{0.8}Ba_{0.2}Yb₂F_{7.2};

FIG. 8A shows a crystalline structure of KYb₂F₇ as a comparative example;

FIG. 8B shows a crystalline structure of BaYb₂F₈ as a comparative example; and

FIG. 9 shows LSV curves of K_{0.9}Ba_{0.1}Yb₂F_{7.1} and K_{0.9}Ba_{0.1}Lu₂F_{7.1}.

### DETAILED DESCRIPTION OF EMBODIMENTS

Hereinbelow, embodiments of the disclosure will be descried in detail. It should be noted that the disclosure is not limited to the following embodiments, and various modifications may be made within the scope of the disclosure.

### Fluoride Ion Conductor

A fluoride ion conductor according to the disclosure is represented by the following composition formula (1):

$${A}_{1 - x} {AE}_{x} {M}_{2} {F}_{7 + x} \qquad ( 1 )$$

(wherein
A=Na, K, Rb, Cs, or a combination thereof;
AE=Ca, Sr, Ba, or a combination thereof;
M=Sc, Y, Ln (Ln is a lanthanoid element), Al, Ga, In, or a combination thereof; and
0<x<1).

The present inventors have found that ion conductivity of a fluoride ion conductor can unexpectedly be improved by replacing, with a predetermined divalent alkaline-earth metal element, part of a predetermined monovalent alkali metal element represented by “A” in AM₂F₇ having a KIn₂F₇-type structure such as one disclosed in Y. LEFUR et al., Structure cristalline de la phase β-KYb₂F₇, Journal of Solid State Chemistry Vol. 35, 1980, pp. 29-33.

Although not intended to be constrained by theory, the reason for this is estimated as follows. Specifically, replacement of part of a predetermined alkali metal element represented by “A” in AM₂F₇ with a predetermined alkaline-earth metal element having a higher valence makes it possible to generate A₁₋ₓAEₓM₂F₇₊ₓ (A: predetermined alkali metal element, AE: predetermined alkaline-earth metal element). It is considered that excessive fluoride ions are introduced into A₁₋ₓAEₓM₂F₇₊ₓ to maintain electric neutrality. Further, it is considered that such excessive fluoride ions are present in relatively unstable sites in a crystalline structure and are therefore likely to move into adjacent sites, thereby allowing the fluoride ion conductor to have improved ion conductivity.

Elements constituting the fluoride ion conductor according to the disclosure will be described below.

In the formula (1) representing the fluoride ion conductor according to the disclosure, A is an alkali metal element selected from among Na, K, Rb, Cs, and a combination thereof, and AE is an alkaline-earth metal element selected from among Ca, Sr, Ba, and a combination thereof. As described above, replacement of part of “A” with “AE” allows the fluoride ion conductor to have improved ion conductivity.

The “lanthanoid element” represented by “Ln” as “M in the formula (1) includes La, Ce, Pr, Nd, Pm, Sm, Eu, Gd, Tb, Dy, Ho, Er, Tm, Yb, and Lu.

In the formula (1) representing the fluoride ion conductor according to the disclosure, x satisfies 0<x<1. That is, in the fluoride ion conductor according to the disclosure, at least part of “A” is replaced with “AE” and not all of “A” is replaced with “AE”. X may be 0.01 or more, 0.025 or more, 0.05 or more, 0.075 or more, 0.1 or more, 0.2 or more, 0.25 or more, 0.3 or more, or 0.35 or more and may be 0.9 or less, 0.8 or less, 0.75 or less, 0.7 or less, 0.6 or less, 0.5 or less, 0.4 or less, 0.35 or less, 0.3 or less, 0.25 or less, 0.2 or less, or 0.1 or less.

The fluoride ion conductor according to the disclosure may be represented by the following composition formula (2):

$${A}_{1 - x} {Ba}_{x} {M}_{2} {F}_{7 + x} \qquad ( 2 )$$

(wherein
A=K, Rb, or a combination thereof;
M=Yb, Lu, or a combination thereof; and
0.025≤x≤0.9).

In the formula (2), A may particularly be K.

In the formula (2), x may be 0.025 or more, 0.05 or more, 0.075 or more, or 0.1 or more and may be 0.75 or less, 0.7 or less, 0.6 or less, 0.5 or less, 0.4 or less, 0.35 or less, 0.3 or less, 0.25 or less, 0.2 or less, or 0.1 or less. When x is within the above range, ion conductivity of the fluoride ion conductor is further improved. Although not intended to be constrained by theory, the reason for this is considered to be that the amount of impurities in the structure of such a fluoride ion conductor is small.

The fluoride ion conductor according to the disclosure may be represented by the following composition formula (3):

$${A}_{1 - x} {Ba}_{x} {Er}_{2} {F}_{7 + x} \qquad ( 3 )$$

(wherein
A=K, Rb, or a combination thereof; and
0.2≤x≤0.8).

In the formula (3), A may particularly be Rb.

In the formula (3), x may be 0.30 or more, 0.35 or more, or 0.4 or more and may be 0.6 or less, 0.5 or less, 0.4 or less, or 0.35 or less. When x is within the above range, ion conductivity of the fluoride ion conductor is further improved. Although not intended to be constrained by theory, the reason for this is considered to be that the amount of impurities in the structure of such a fluoride ion conductor is small.

The fluoride ion conductor according to the disclosure may be represented by the following composition formula (4):

$${K}_{1 - x} {Ba}_{x} {Lu}_{2} {F}_{7 + x} \qquad ( 4 )$$

(wherein 0.025≤x≤0.5).

The fluoride ion conductor represented by the formula (4) has not only high ion conductivity but also wide potential window and therefore has high reduction resistance. Although not intended to be constrained by theory, the reason for this is considered to be that Lu is used as “M” instead of an element that is easily reduced, such as Yb.

In the formula (4), x may be 0.05 or more, 0.075 or more, or 0.1 or more and may be 0.4 or less, 0.35 or less, 0.3 or less, 0.25 or less, 0.2 or less, or 0.1 or less.

Whether or not the fluoride ion conductor according to the disclosure has been produced can be determined by X-ray diffraction (XRD). Specifically, the material is measured using SmartLab (manufactured by Rigaku Holdings Corporation) equipped with a CuKα1 radiation source in an atmosphere of argon under conditions of a measurement range of 10° to 60°, a scan rate of 1.5°/min, and a measurement pitch of 0.01° to determine the presence or absence of peaks described below:
one peak at 16±2°, one peak at 21±2°, one peak at 30.5±2°, one peak at 33.5±2°, and one peak at 35±2°; and
four peaks in the range of 26±2° to 28±2°.

A method for producing the fluoride ion conductor according to the disclosure is not limited. For example, raw material compounds may be mixed, followed by baking a resultant in an atmosphere of an inert gas.

The raw material compounds are not limited. For example, in the case of the fluoride ion conductor represented by the formula (1) wherein A=K, AE=Ba, and M=Yb, raw material compounds may be potassium fluoride (KF), barium fluoride (BaF₂), and ytterbium fluoride (YbF₃). These raw material compounds may be those prepared by ordinary methods or commercially-available products.

A method for mixing the raw material compounds is not limited and may be, for example, mixing using an agate mortar. A mixing time is not limited and may be, for example, 10 minutes or more, 20 minutes or more, or 30 minutes or more and 3 hours or less, 2 hours or less, 1 hour or less, or 30 minutes or less.

The inert gas used for baking may be, for example, argon gas, nitrogen gas, or the like. A baking temperature is not limited and may be, for example 500° C. or more, 700° C. or more, 800° C. or more, or 900° C. or more and 1300° C. or less, 1100° C. or less, 1000° C. or less, or 900° C. or less. A baking time is not limited and may be, for example, 10 hours or more, 11 hours or more, or 12 hours or more and 15 hours or less, 14 hours or less, 13 hours or less, or 12 hours or less.

The form of the fluoride ion conductor is not limited and may be, for example, a green compact or a sintered body. The green compact can be obtained by applying pressure to the obtained fluoride ion conductor. The sintered body can be obtained by further heating the green compact under vacuum or in an atmosphere of an inert gas

### Fluoride Ion Battery

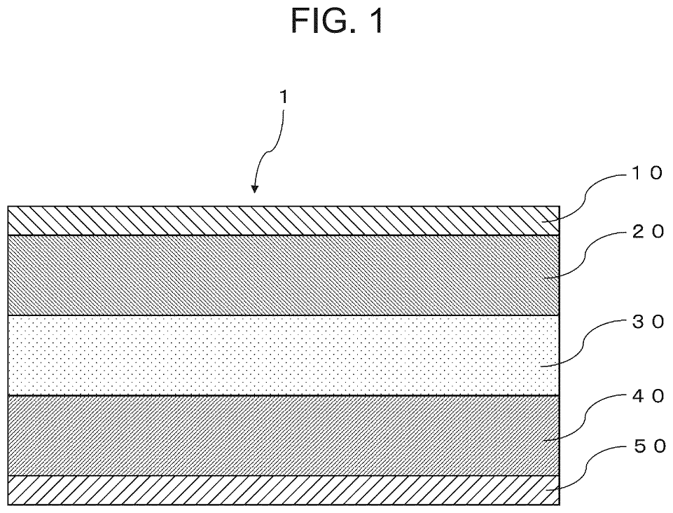

As shown in FIG. 1 as an example, a fluoride ion battery 1 according to the disclosure includes the fluoride ion conductor according to the disclosure as a solid electrolyte for fluoride ion batteries. For the fluoride ion conductor according to the disclosure, refer to the above description of the fluoride ion conductor according to the disclosure.

As shown in FIG. 1 as an example, the fluoride ion battery 1 according to the disclosure may include a negative electrode current collector layer 10, a negative electrode active material layer 20, an electrolyte layer 30, a positive electrode active material layer 40, and a positive electrode current collector layer 50 stacked in this order.

The fluoride ion conductor according to the disclosure may be contained, as a solid electrolyte, in at least any one of a positive electrode active material layer, an electrolyte layer, and a negative electrode active material layer. For example, the fluoride ion conductor according to the disclosure may be contained in a negative electrode active material layer and an electrolyte layer or may be contained only in an electrolyte layer.

When the fluoride ion conductor according to the disclosure is contained in an electrolyte layer, the fluoride ion battery according to the disclosure may be a solid-state battery. When the fluoride ion conductor according to the disclosure is contained in a positive electrode active material layer and/or a negative electrode active material layer, the fluoride ion battery according to the disclosure may be a liquid-type battery including an electrolytic solution as an electrolyte layer or a solid-state battery having a solid electrolyte layer as an electrolyte layer. It should be noted that the “solid-state battery” herein means a battery using at least a solid electrolyte as an electrolyte, and therefore the solid-state battery may use, as an electrolyte, a combination of a solid electrolyte and a liquid electrolyte. The solid-state battery according to the disclosure may be an all-solid-state battery, that is, a battery using only a solid electrolyte as an electrolyte.

Elements constituting the fluoride ion battery according to the disclosure will be described below.

### Negative Electrode Current Collector Layer

Examples of the material of a negative electrode current collector layer include stainless steel (SUS), copper, nickel, iron, titanium, platinum, and carbon.

Examples of the form of the negative electrode current collector layer include a foil, a mesh and a porous body.

### Negative Electrode Active Material Layer

A negative electrode active material layer contains a negative electrode active material and may optionally contain a solid electrolyte, a conductive auxiliary agent, and a binder.

The thickness of the negative electrode active material layer is not limited and can appropriately be adjusted depending on the structure of the battery.

### Negative Electrode Active Material

The negative electrode active material is usually a compound that is defluorinated at the time of charge. Examples of such a negative electrode active material include fluorides of an elemental metal, an alloy and a metal oxide. Examples of a metal element contained in the negative electrode active material include La, Ca, Al, Eu, Li, Si, Ge, Sn, In, V, Cd, Cr, Fe, Zn, Ga, Ti, Nb, Mn, Yb, Zr, Sm, Ce, Mg, and Pb. Particularly, the negative electrode active material may be MgF_{z}, AlF_{z}, LaF_{z}, CeF_{z}, CaF_{z}, or PbF_{z}. It should be noted that the z is a real number larger than zero.

### Solid Electrolyte

The solid electrolyte may be the fluoride ion conductor according to the disclosure, a solid electrolyte usually used as a solid electrolyte for fluoride ion batteries, or a combination thereof. When neither an electrolyte layer nor a positive electrode active material layer contains the fluoride ion conductor according to the disclosure, the fluoride ion conductor according to the disclosure may be contained as a solid electrolyte in the negative electrode active material layer.

### Conductive Auxiliary Agent

Examples of the conductive auxiliary agent include carbon materials. Examples of the carbon materials include carbon blacks such as acetylene black, ketchen black, furnace black, and thermal black, graphene, fullerene, and carbon nanotubes.

### Binder

Examples of the binder include fluorine-based binders such as polyvinylidene fluoride (PVdF) and polytetrafluoroethylene (PTFE).

### Electrolyte Layer

When the fluoride ion battery according to the disclosure is a liquid-type battery, an electrolyte layer may be constituted from, for example, an electrolytic solution and an optional separator.

### Electrolytic Solution

The electrolytic solution may contain, for example, a fluoride salt and an organic solvent.

### Separator

The separator is not limited as long as its composition can withstand use in the fluoride ion battery.

When the fluoride ion battery according to the disclosure is a solid-state battery, an electrolyte layer may contain, for example, a solid electrolyte. In this case, the electrolyte layer may optionally contain a binder.

### Solid Electrolyte

The solid electrolyte may be the fluoride ion conductor according to the disclosure, a solid electrolyte usually used as a solid electrolyte for fluoride ion batteries, or a combination thereof. When neither a negative electrode active material layer nor a positive electrode active material layer contains the fluoride ion conductor according to the disclosure, the fluoride ion conductor according to the disclosure may be contained as a solid electrolyte in the electrolyte layer. In this case, the electrolyte layer may be formed of the fluoride ion conductor according to the disclosure as a single solid electrolyte.

### Binder

For the binder, refer to the above description made with reference to the negative electrode active material layer according to the disclosure.

### Positive Electrode Active Material Layer

A positive electrode active material layer according to the disclosure contains a positive electrode active material and may optionally contain a solid electrolyte, a conductive auxiliary agent, and a binder.

The thickness of the positive electrode active material layer is not limited and may appropriately be adjusted depending on the structure of the battery.

### Positive Electrode Active Material

The positive electrode active material is an active material that is usually defluorinated at the time of discharge. Examples of such a positive electrode active material include an elemental metal, an alloy, a metal oxide, and fluorides thereof. Examples of a metal element contained in the positive electrode active material include Cu, Ag, Ni, Co, Pb, Mn, Au, Pt, Rh, V, Os, Ru, Fe, Cr, Bi. Nb, Sb, Ti, Sn, and Zn.

### Solid Electrolyte

The solid electrolyte may be the fluoride ion conductor according to the disclosure, a solid electrolyte usually used as a solid electrolyte for fluoride ion batteries, or a combination thereof. When neither a negative electrode active material layer nor an electrolyte layer contains the fluoride ion conductor according to the disclosure, the fluoride ion conductor according to the disclosure may be contained as a solid electrolyte in the positive electrode active material layer.

### Conductive Auxiliary Agent and Binder

For the conductive auxiliary agent and the binder, refer to the above description made with reference to the negative electrode active material layer according to the disclosure.

### Positive Electrode Current Collector Layer

Examples of the material of a positive electrode current collector layer include lead, stainless steel (SUS), aluminum, nickel, iron, titanium, platinum, and carbon.

Examples of the form of the positive electrode current collector layer include a foil, a mesh, and a porous body.

### Example 1-1

### Preparation of Evaluation Sample

### Synthesis of Fluoride Ion Conductor

Potassium fluoride (KF), Barium fluoride (BaF₂), and ytterbium fluoride (YbF₃) (all of which were produced by Aldrich) were weighed such that a composition of K_{0.975}Ba_{0.025}Yb₂F_{7.025} was achieved and were mixed in an agate mortar for 30 minutes to obtain a mixed powder. The mixed powder was placed in a copper (Cu) tube in an atmosphere of argon (Ar), and both of the ends of the Cu tube were folded with nippers to hermetically seal the Cu tube containing the mixed powder. The Cu tube was baked in a tubular furnace at 900° C. for 12 hours. After naturally cooled, the Cu tube was opened in a glovebox under an atmosphere of Ar to obtain a fluoride ion conductor powder.

### Production of Green Compact

The obtained fluoride ion conductor powder was subjected to uniaxial pressing at 340 MPa to obtain a green compact.

### Evaluations

### X-Ray Diffraction Measurement

The synthetically-obtained fluoride ion conductor powder was measured by X-ray diffraction (XRD) using SmartLab (manufactured by Rigaku Holdings Corporation) equipped with a CuKα1 radiation source under the following conditions:

| atmosphere | under atmosphere of Ar |
|---|---|
| measurement range | 10° to 60° |
| scan rate | 1.5°/min |
| measurement pitch | 0.01° |

### Ion Conductivity

A gold powder was pressed onto the upper and lower surfaces of the obtained fluoride ion conductor green compact to attach gold electrodes thereto, and ion conductivity was measured by alternating-current impedance measurement under the following conditions:

| | |
|---|---|
| frequency range | 7 MHz to 0.5 Hz |
| applied voltage | 100 mV |
| atmosphere | under stream of argon |
| temperature | 25° C. to 400° C. |

### Examples 1-2 to 1-14, Example 2-1, Examples 3-1 to 3-7, Examples 4-1 and 4-2, Comparative Examples 1-1 and 1-2, and Reference Examples 2-1 and 2-2

A fluoride ion conductor powder and a green compact of each example were produced and evaluated in the same manner as in Example 1-1 except that the composition was changed as shown in Tables 1 to 4. It should be noted that raw materials used other than those described above are as described below, and all of the raw materials were produced by Aldrich:
RbF, ScF₃, LuF₃, TmF₃, ErF₃, DyF₃, YF₃, and ErF₃.

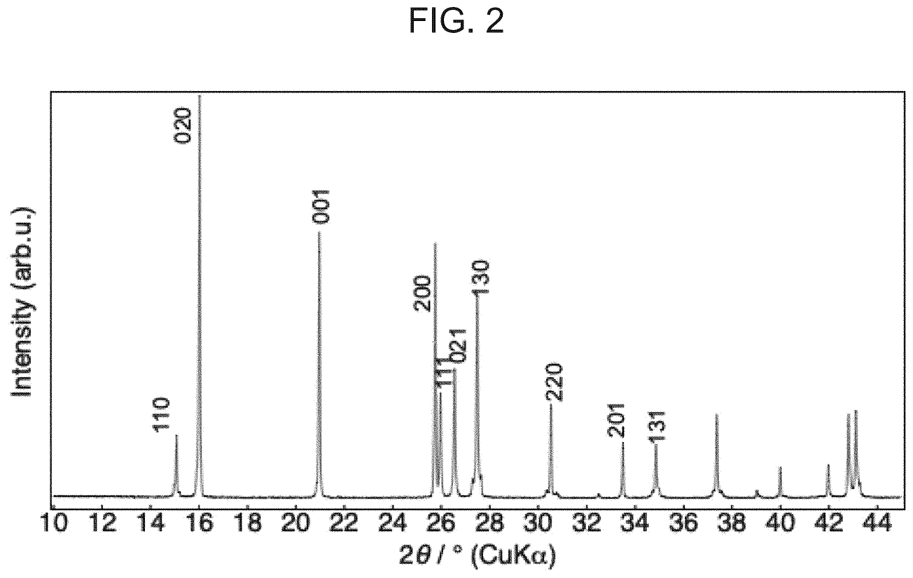

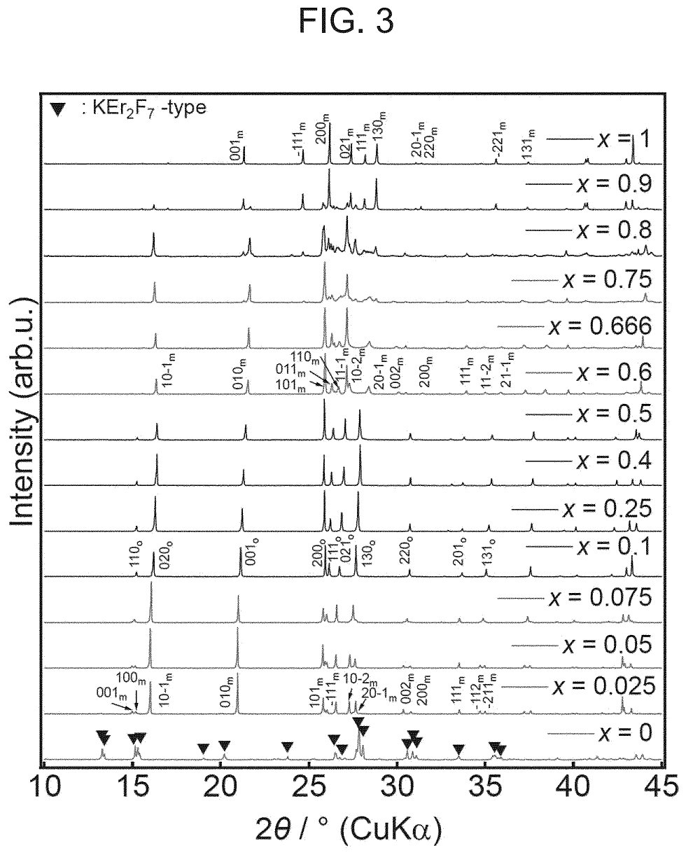

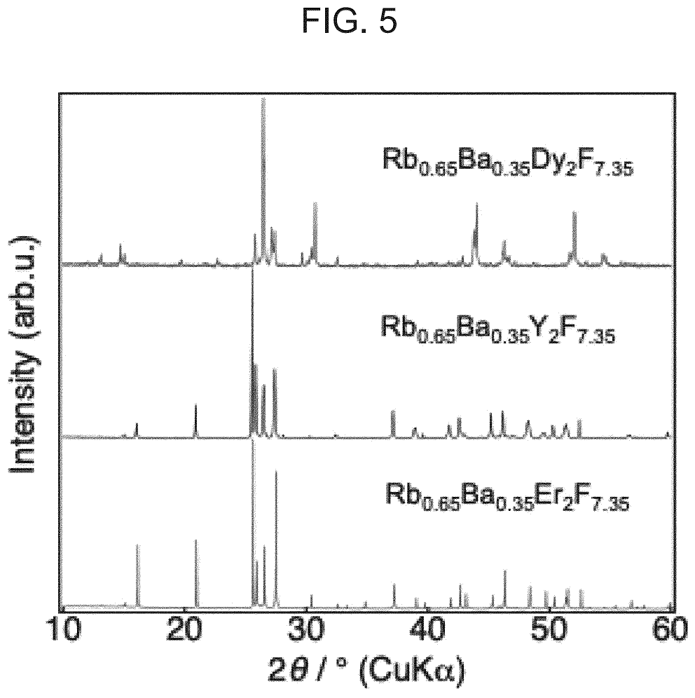

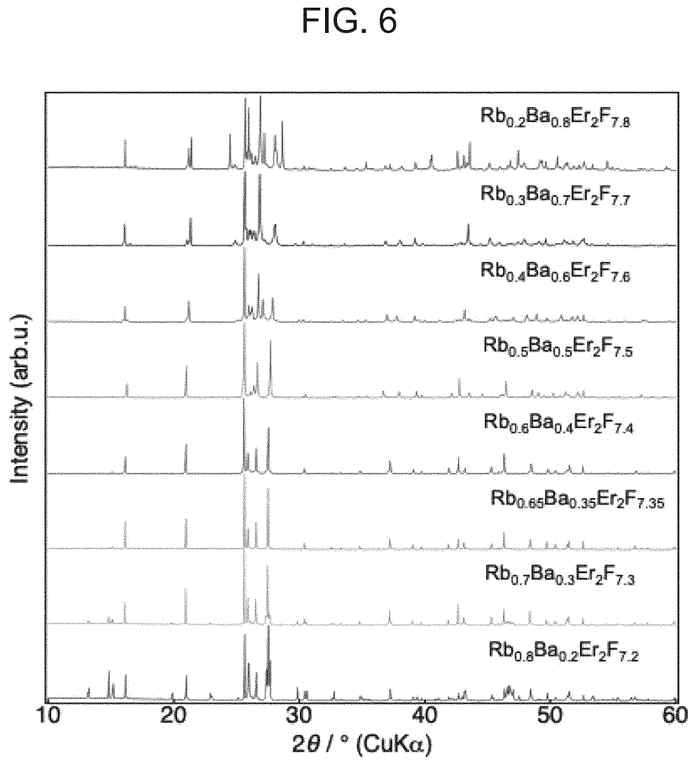

The composition, ion conductivity, and state of a generated phase of the fluoride ion conductor of each example are shown in Tables 1 to 4. The state of a generated phase was determined by an XRD spectrum shown in FIGS. 2 to 6.

TABLE 1
Table 1

| | | | Ion Conductivity | |
|---|---|---|---|---|
| | Composition | X | [S · cm⁻¹] (25° C.) | Generated Phase |
| Comparative | KYb₂F₇ | 0 | 1.30E−15 | KEr₂F₇-type Phase |
| Example 1-1 | | | | |
| Example 1-1 | K_{0.975}Ba_{0.025}Yb₂F_{7.025} | 0.025 | 1.20E−09 | KIn₂F₇-type Phase |
| Example 1-2 | K_{0.95}Ba_{0.05}Yb₂F _{7.05} | 0.05 | 1.10E−08 | KIn₂F₇-type Phase |
| Example 1-3 | K_{0.925}Ba_{0.075}Yb₂F_{7.075} | 0.075 | 2.30E−08 | KIn₂F₇-type Phase |
| Example 1-4 | K_{0.9}Ba_{0.1}Yb₂F_{7.1} | 0.1 | 1.30E−07 | KIn₂F₇-type Phase |
| Example 1-5 | K_{0.8}Ba_{0.2}Yb₂F_{7.2} | 0.2 | 6.00E−08 | KIn₂F₇-type Phase |
| Example 1-6 | K_{0.7}Ba_{0.3}Yb₂F_{7.3} | 0.25 | 3.20E−08 | KIn₂F₇-type Phase |
| Example 1-7 | K_{0.667}Ba_{0.333}Yb₂F_{7.333} | 0.333 | 1.50E−08 | KIn₂F₇-type Phase |
| Example 1-8 | K_{0.6}Ba_{0.4}Yb₂F_{7.4} | 0.4 | 5.00E−09 | KIn₂F₇-type Phase |
| Example 1-9 | K_{0.5}Ba_{0.5}Yb₂F_{7.5} | 0.5 | 2.10E−09 | KIn₂F₇-type Phase |
| Example 1-10 | K_{0.4}Ba_{0.6}Yb₂F_{7.6} | 0.6 | 3.60E−10 | KIn₂F₇-type Phase |
| Example 1-11 | K_{0.333}Ba_{0.667}Yb₂F_{7.667} | 0.667 | 1.00E−10 | KIn₂F₇-type Phase |
| Example 1-12 | K_{0.25}Ba_{0.75}Yb₂F_{7.75} | 0.75 | 1.60E−09 | KIn₂F₇-type Phase |
| Example 1-13 | K_{0.2}Ba_{0.8}Yb₂F_{7.8} | 0.8 | 1.80E−10 | KIn₂F₇-type Phase + |
| | | | | Second Phase |
| Example 1-14 | K_{0.1}Ba_{0.9}Yb₂F_{7.9} | 0.9 | 1.40E−10 | KIn₂F₇-type Phase + |
| | | | | Second Phase |
| Comparative | BaYb₂F₈ | 1 | 1.90E−12 | BaTm₂F₈-type Phase |
| Example 1-2 | | | | |

TABLE 2
Table 2

| | | | Ion Conductivity | |
|---|---|---|---|---|
| | Composition | X | [S · cm⁻¹] (25° C.) | Generated Phase |
| Example 2-1 | K_{0.9}Ba_{0.1}Sc₂F_{7.1} | 0.1 | 1.47E−11 | KIn₂F₇-type Phase |
| Reference | K_{0.9}Ba_{0.1}Tm₂F_{7.1} | 0.1 | 5.65E−13 | Another Structure |
| Example 2-1 | | | | |
| Reference | K_{0.9}Ba_{0.1}Er₂F _{7.1} | 0.1 | n.d. ¹⁾ | Another Structure |
| Example 2-2 | | | | |

¹⁾ no data

TABLE 3
Table 3

| | | | Ion Conductivity | |
|---|---|---|---|---|
| | Composition | X | [S · cm⁻¹] (25° C.) | Generated Phase |
| Example 3-1 | Rb_{0.8}Ba_{0.2}Er₂F_{7.2} | 0.2 | 8.50E−10 | KIn₂F₇-type Phase + |
| | | | | Pnma |
| Example 3-2 | Rb_{0.7}Ba_{0.3}Er₂F_{7.3} | 0.3 | 7.00E−09 | KIn₂F₇-type Phase |
| Example 3-3 | Rb_{0.65}Ba_{0.35}Er₂F_{7.35} | 0.35 | 1.40E−08 | KIn₂F₇-type Phase |
| Example 3-4 | Rb_{0.6}Ba_{0.4}Er₂F_{7.4} | 0.4 | 1.10E−08 | KIn₂F₇-type Phase |
| Example 3-5 | Rb_{0.4}Ba_{0.6}Er₂F_{7.6} | 0.6 | 4.20E−09 | KIn₂F₇-type Phase |
| Example 3-6 | Rb_{0.3}Ba_{0.7}Er₂F_{7.7} | 0.7 | 3.00E−10 | BaEr₂F₈ + KIn₂F₇ |
| Example 3-7 | Rb_{0.2}Ba_{0.8}Er₂F_{7.8} | 0.8 | 3.90E−10 | BaEr₂F₈ + KIn₂F₇ |

TABLE 4
Table 4

| | | | Ion Conductivity | |
|---|---|---|---|---|
| | Composition | X | [S · cm⁻¹] (25° C.) | Generated Phase |
| Example 3-3 | Rb_{0.65}Ba_{0.35}Er₂F_{7.35} | 0.35 | 1.40E−08 | KIn₂F₇-type Phase |
| Example 4-1 | Rb_{0.65}Ba_{0.35}Dy₂F_{7.35} | 0.35 | 3.32E−11 | KIn₂F₇-type Phase |
| Example 4-2 | Rb_{0.65}Ba_{0.35} Y₂F_{7.35} | 0.35 | 2.74E−09 | KIn₂F₇-type Phase |

As shown in FIGS. 2 to 6, the fluoride ion conductors of Examples were confirmed to have the following peaks:
one peak at 16±2°, one peak at 21±2°, one peak at 30.5±2°, one peak at 33.5±2°, and one peak at 35±2°; and
four peaks in the range of 26±2° to 28±2°.

As shown in Tables 1 to 4, the fluoride ion conductors of Examples obtained by replacement of a predetermined alkali metal element with a predetermined alkaline-earth metal element had higher ion conductivity than the fluoride ion conductors of Comparative Examples.

The reason for this is considered to be that when part of a predetermined alkali metal element of a fluoride ion conductor was replaced with a predetermined alkaline-earth metal element having a higher valence, excessive fluoride ions were introduced to maintain electric neutrality, and therefore the fluoride ions were likely to diffuse.

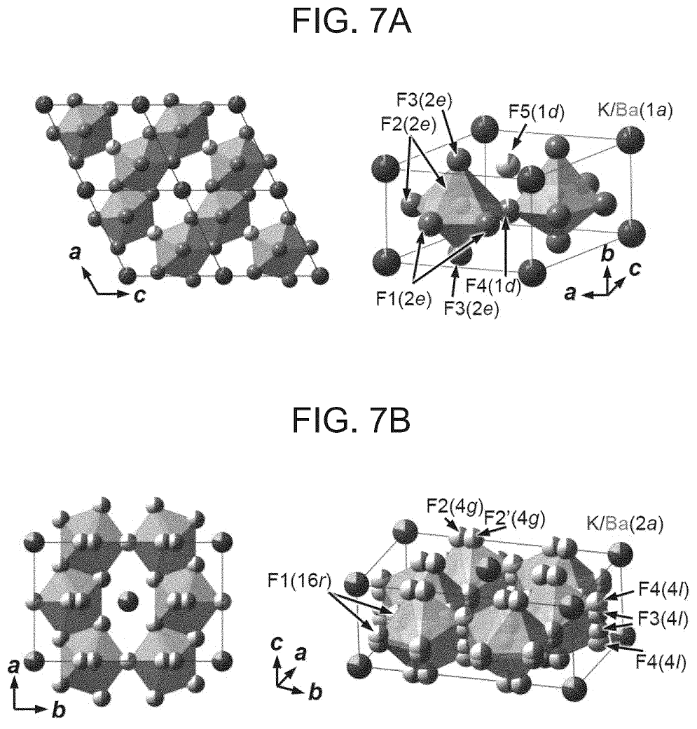

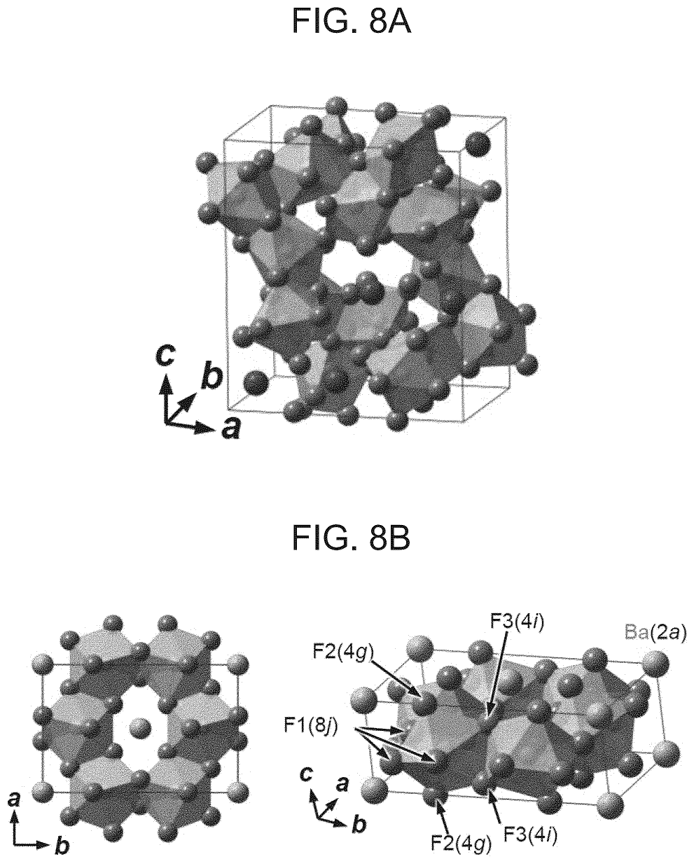

It should be noted that the crystalline structures of the fluoride ion conductors of Examples 1-1 and 1-5 and the crystalline structures of the fluoride ion conductors of Comparative Examples 1-1 and 1-2 are shown in FIG. 7A and FIG. 7B and FIG. 8A and FIG. 8B, respectively.

Table 1 and Table 3 confirmed that when the generated phase was a single phase of KIn₂F₇-type, that is, when the amount of impurities was too small to be detected, the ion conductivity tended to be high.

### Examples 5-1 to 5-3

### Preparation of Evaluation Samples

### Production of Sintered Body

A fluoride ion conductor powder of each example was synthesized and a green compact thereof was further produced in the same manner as in Example 1-1 except that the composition was changed as shown in Table 5. The obtained green compact was wrapped with a platinum (Pt) foil and enclosed in a quartz ampule under vacuum. The ampule was heated at 800° C. for 12 hours to obtain a sintered body.

### Evaluations

### X-Ray Diffraction Measurement

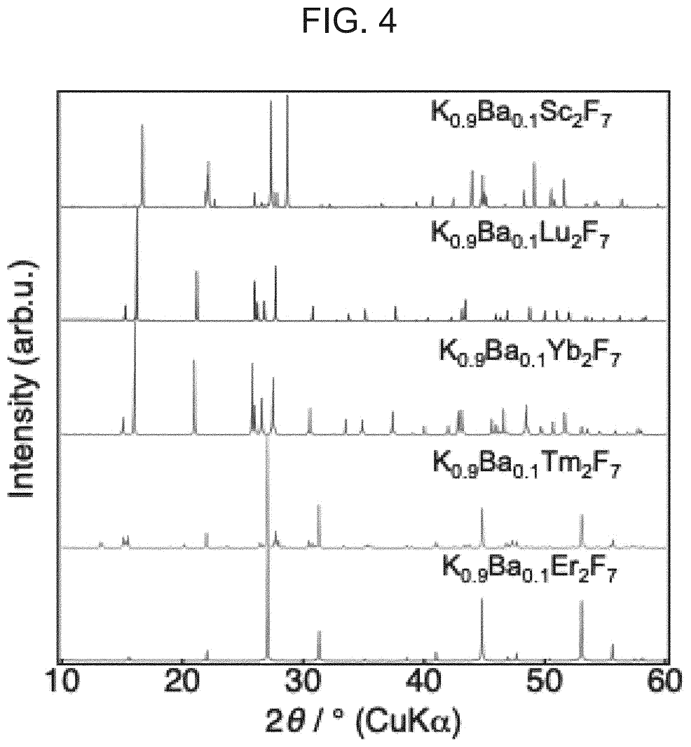

The fluoride ion conductor powders of Examples 5-1 to 5-3 were evaluated in the same manner as in Example 1-1. The evaluation results are shown in FIG. 4 together with the evaluations results of fluoride ion conductor powders similar in composition.

### Ion Conductivity

Pt films were formed as electrodes by sputtering on the upper and lower surfaces of the obtained fluoride ion conductor sintered body, and ion conductivity was measured by alternating-current impedance measurement under the following conditions:

| | |
|---|---|
| frequency range | 100 MHz to 100 Hz |
| applied voltage | 10 mV to 100 mV |
| atmosphere | under stream of argon |

temperature: 25° C. to 200° C.

### Potential Window

Lead fluoride (PbF₂) (produced by Aldrich) and acetylene black (AB) (produced by Denka Company Limited) were weighed such that a mass ratio was 95:5. They were mixed in a ball mill at 600 rpm for 3 hours to obtain a counter electrode mixture.

A Pt foil, the fluoride ion conductor sintered body as an electrolyte layer, a counter electrode mixture layer, a Pb foil, and an aluminum (Al) foil were stacked in this order and subjected to powder compaction to produce a battery for evaluation.

The produced battery for evaluation was subjected to linear sweep voltammetry (LSV) measurement to a final potential of −3 V under conditions of −50 μAcm⁻² and 150° C.

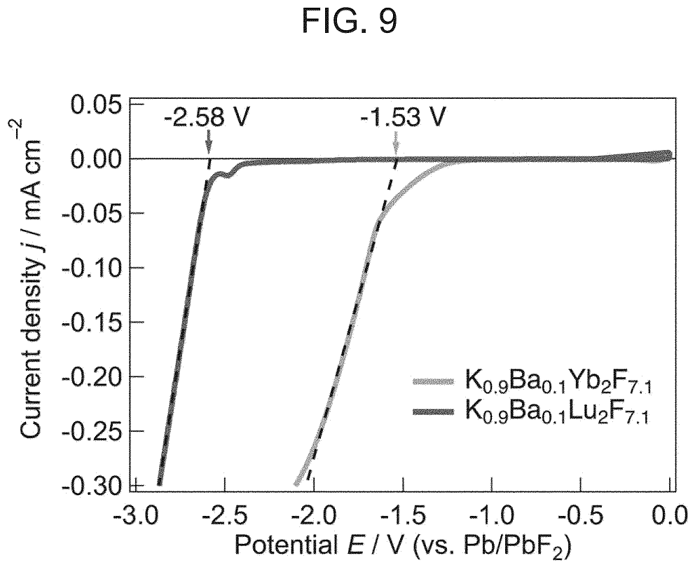

The composition, ion conductivity, and state of a generated phase of the fluoride ion conductor of each example are shown in Table 5. It should be noted that for comparison, Table 5 also shows the composition, ion conductivity, and state of a generated phase of the green compacts (Example 1-4 and Example 3-3) respectively corresponding to Example 5-1 and Example 5-3 in terms of composition. Further, the LSV curves of the fluoride ion conductors of Examples 5-1 and 5-2 are shown in FIG. 9.

TABLE 5
Table 5

| | | | Ion Conductivity | |
|---|---|---|---|---|
| | Composition | X | [S · cm⁻¹] (25° C.) | Generated Phase |
| Example 1-4 | K_{0.9}Ba_{0.1}Yb₂F_{7.1}(Green Compact) | 0.1 | 1.30E−07 | KIn₂F₇-type Phase |
| Example 5-1 | K_{0.9}Ba_{0.1}Yb₂F_{7.1}(Sintered Body) | 0.1 | 1.90E−06 | KIn₂F₇-type Phase |
| Example 5-2 | K_{0.9}Ba_{0.1}Lu₂F_{7.1}(Sintered Body) | 0.1 | 1.30E−06 | KIn₂F₇-type Phase |
| Example 3-3 | Rb_{0.65}Ba_{0.35}Er₂F_{7.35}(Green Compact) | 0.35 | 1.40E−08 | KIn₂F₇-type Phase |
| Example 5-3 | Rb_{0.65}Ba_{0.35}Er₂F_{7.35}(Sintered | 0.35 | 1.30E−06 | KIn₂F₇-type Phase |
| | Body) | | | |

As shown in Table 5, the sintered bodies had higher ion conductivity than the green compacts. The reason for this is considered to be that the contact area between powder particles in the fluoride ion conductor sintered body was large, and therefore fluoride ions were likely to diffuse.

As shown in FIG. 9, the fluoride ion conductor of Example 5-2 having Lu as M had a larger reduction potential and a wider potential window than the fluoride ion conductor of Example 5-1 having Yb as M. That is, the fluoride ion conductor of Example 5-2 had high reduction resistance. It should be noted that evaluation of reduction resistance was performed on the fluoride ion conductor sintered bodies, but it is considered that sintering of a fluoride ion conductor does not contribute to reduction resistance. Therefore, it is considered that also when evaluation of reduction resistance is performed on the fluoride ion conductor green compacts, the same evaluation results are obtained.

What is claimed is:

1. A fluoride ion conductor represented by the following composition formula (1):
$${A}_{1 - x} {AE}_{x} {M}_{2} {F}_{7 + x} \qquad ( 1 )$$
wherein
A=Na, K, Rb, Cs, or a combination of the elements;
AE=Ca, Sr, Ba, or a combination of the elements;
M=Sc, Y, Ln wherein Ln is a lanthanoid element, Al, Ga, In, or a combination of the elements; and
0<x<1.

2. The fluoride ion conductor according to claim 1 represented by the following composition formula (2):
$${A}_{1 - x} {Ba}_{x} {M}_{2} {F}_{7 + x} \qquad ( 2 )$$
wherein
A=K, Rb, or a combination of the elements;
M=Yb, Lu, or a combination of the elements; and
0.025≤x≤0.9.

3. The fluoride ion conductor according to claim 1 represented by the following composition formula (3):
$${A}_{1 - x} {Ba}_{x} {Er}_{2} {F}_{7 + x} \qquad ( 3 )$$
wherein
A=K, Rb, or a combination of the elements; and
0.2≤x≤0.8.

4. The fluoride ion conductor according to claim 1 represented by the following composition formula (4):
$${K}_{1 - x} {Ba}_{x} {Lu}_{2} {F}_{7 + x} \qquad ( 4 )$$
wherein 0.025≤x≤0.5.

5. A fluoride ion battery comprising the fluoride ion conductor according to claim 1 as a solid electrolyte for fluoride ion batteries.
